(19) United States
(12) Patent Application Publication
(10) Pub. No.: US 2024/0128573 A1
(43) Pub. Date: Apr. 18, 2024

(54) STACKABLE FRAME DESIGN FOR POUCH CELL BATTERY PACKS

(71) Applicant: Enphase Energy, Inc., Petaluma, CA (US)

(72) Inventors: Christopher McNair LYKE, Austin, TX (US); Wei JIANG, Round Rock, TX (US)

(21) Appl. No.: 18/377,155

(22) Filed: Oct. 5, 2023

Related U.S. Application Data
(60) Provisional application No. 63/415,337, filed on Oct. 12, 2022.

(51) Int. Cl. H01M 50/258; H01M 50/211; H01M 50/244; H01M 50/264; H01M 50/293; H01M 50/51; H01M 50/519

(52) U.S. Cl. CPC H01M 50/258; H01M 50/211; H01M 50/244; H01M 50/264; H01M 50/293; H01M 50/51; H01M 50/519

(57) ABSTRACT

The present disclosure provides an energy storage system. For example, an energy storage system comprises a printed circuit board assembly configured to connect to a chassis of the energy storage system and a frame assembly comprising a plurality of stackable frames configured to connect to a plurality of battery cells and the printed circuit board assembly such that a series connection between the plurality of battery cells is created when the plurality of battery cells are connected to the plurality of stackable frames.

### CROSS-REFERENCE TO RELATED APPLICATIONS

The present application claims the benefit of and priority to U.S. Provisional Application Ser. No. 63/415,337, filed on Oct. 12, 2022, the entire contents of which is incorporated herein by reference.

### BACKGROUND

### Field of the Disclosure

Embodiments of the present disclosure relate generally to energy storage systems, and, for example, to stackable frame design for pouch cell battery packs.

### Description of the Related Art

Conventional energy storage systems (battery systems) can comprise one or more cells that connect to one or more PCBA (printed circuit boards assemblies) via one or more terminal connectors. For example, cylindrical cell configurations can be electrically connected to the PCBA using spot or wedge welding on metal bus bars or by using bolts to connect cells with threaded tabs. As such an approach mostly requires automatic welding lines, field replacement of problematic cells to avoid unnecessary RMA of an entire battery module is not possible or can be extremely difficult to conduct (e.g., each screw must be removed layer by layer).

Pouch cell configurations can be electrically connected using either welding (e.g., ultrasonic, laser, etc.) or screws. The former, however, is not suitable for field replacement of cells, and the latter is a complex assembling process (i.e., a requires sorting out the tabs, screw securing the tabs on to a bus bar, and/or connecting sensing cables). While the aforementioned method is suitable for connecting the various cell configurations, such methods are not configured for fast engagement/assembling without heavy investment in equipment and are not configured for fast disengagement to enable field replacement of cells.

Accordingly, there is a need for improved stackable frame design for pouch cell battery packs.

### SUMMARY

In accordance with some aspects of the disclosure, an energy storage system comprises a printed circuit board assembly configured to connect to a chassis of the energy storage system and a frame assembly comprising a plurality of stackable frames configured to connect to a plurality of battery cells and the printed circuit board assembly such that a series connection between the plurality of battery cells is created when the plurality of battery cells are connected to the plurality of stackable frames.

In accordance with some aspects of the disclosure, an energy management system comprises a distributed energy resource comprising a renewable energy source, a load center connected to the renewable energy source, and an energy storage system, comprising a printed circuit board assembly configured to connect to a chassis of the energy storage system and a frame assembly comprising a plurality of stackable frames configured to connect to a plurality of battery cells and the printed circuit board assembly such that a series connection between the plurality of battery cells is created when the plurality of battery cells are connected to the plurality of stackable frames.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIGS. 2A-2E are diagrams of a pouch cell electrical configuration, in accordance with one or more embodiments of the present disclosure; and

FIG. 3 is a diagram of the pouch cell electrical configuration of FIGS. 2A-2E shown connected to a chassis of an energy storage system configured for use with the energy management system of FIG. 1, in accordance with one or more embodiments of the present disclosure.

### DETAILED DESCRIPTION

Embodiments of the present disclosure relate to stackable frame designs for pouch cell battery packs. For example, an energy storage system comprises a printed circuit board assembly configured to connect to a chassis of the energy storage system. A frame assembly comprises a plurality of stackable frames configured to connect to a plurality of battery cells and the printed circuit board assembly such that a series connection between the plurality of battery cells is created when the plurality of battery cells are connected to the plurality of stackable frames. The apparatus described herein provide a pouch cell frame design that enables a cell-to-system assembly and connection of the pouch cell tabs to be completed in one process without the use of additional bolts, clamps, and bus bars for connecting the cells Additionally, the apparatus described herein provide relatively easy field replacement of battery cells, thus alleviating the need for total module RMA and provides potential commercial advantages to sale.

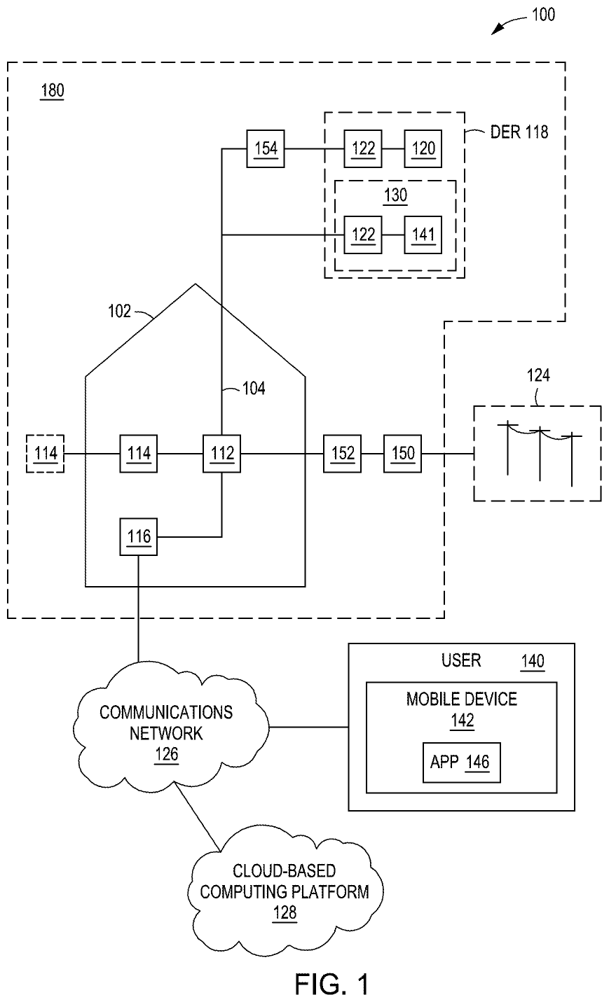

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10®) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a battery 141 may be referred to as an AC battery 130.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads and/or the energy storage system 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as 10S, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

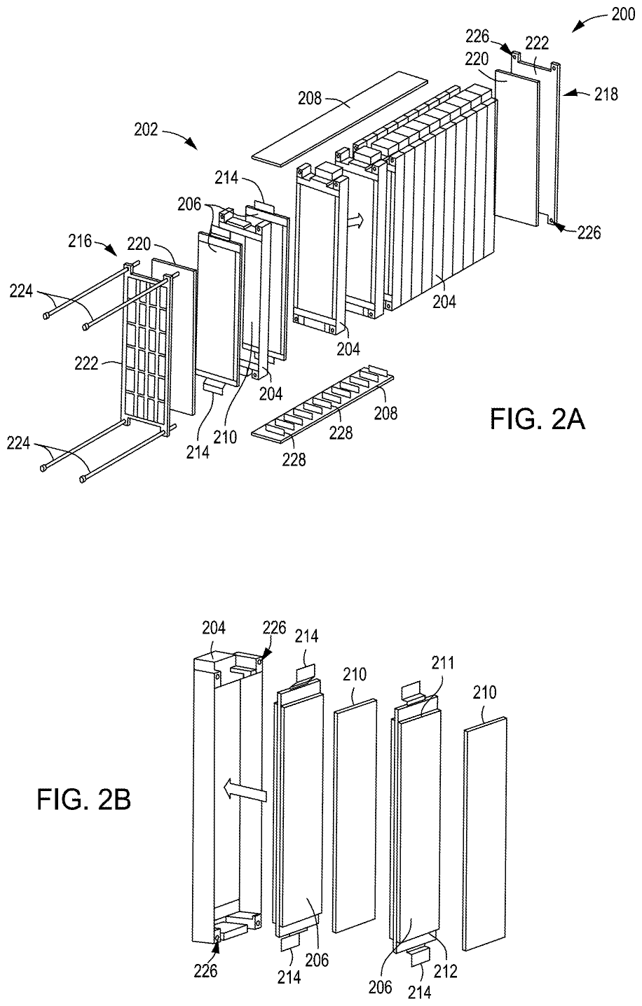

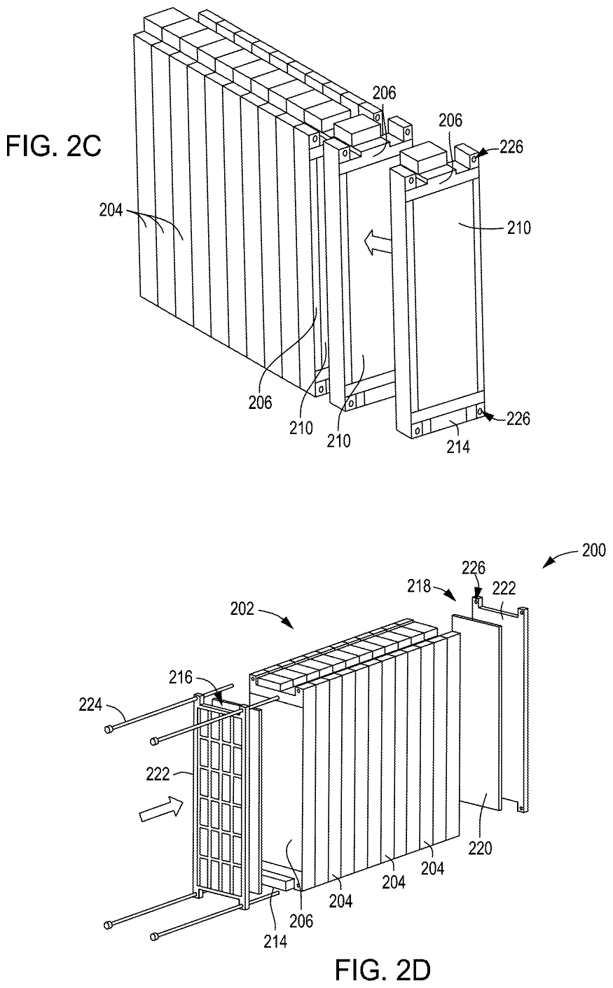

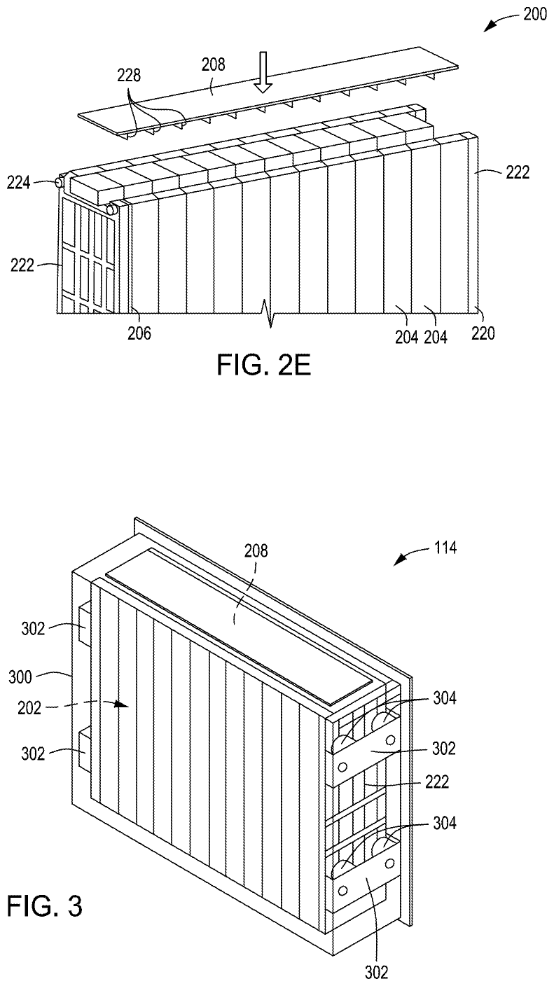

FIGS. 2A-2E are diagrams of a pouch battery cell electrical configuration 200, and FIG. 3 is a diagram of the pouch battery cell electrical configuration 200 of FIGS. 2A-2E shown connected to a chassis of an energy storage system (e.g., the energy storage system 114) configured for use with the energy management system of FIG. 1, in accordance with one or more embodiments of the present disclosure.

For example, the pouch battery cell electrical configuration 200 comprises a frame assembly 202 that comprises a plurality of stackable frames 204 configured to connect to a plurality of battery cells 206 and a printed circuit board assembly 208 (two printed circuit board assemblies are shown) such that a series connection between the plurality of battery cells 206 is created when the plurality of battery cells 206 are connected to the plurality of stackable frames 204. For example, each battery cell of the plurality of battery cells 206 comprises a pair of tabs 214 (e.g., top and bottom tabs) that are configured to provide the series connection between each battery cell of the plurality of battery cells 206. For example, the top tab of adjacent battery cells are bent inward or towards each other and the bottom tab of the same adjacent battery cells are bent outward or away from each other (as shown in FIG. 2B). Thus, when the frame assembly 202 is in an assembled or tightened configuration, a series connection between adjacent battery cells can be achieved.

The pouch battery cell electrical configuration 200 comprises a plurality of compression pads 210. Each compression pad of the plurality of compression pads 210 is configured to be positioned between two adjacent battery cells of the plurality of battery cells 206. For example, each battery cell can comprise a top flange 211 and a bottom flange 212 in which a compression pad can be positioned to secure the compression pad to the battery cell. Other devices and/or methods can be used to secure a compression pad to a battery cell. The compression pad is configured to isolate adjacent battery cells from each other (e.g., to prevent shorts from occurring between adjacent battery cells). Alternatively, the flanges need not be used and the compression pads can be secured by being compressed between the battery cells.

A first pair of insulators and plates 216 and a second pair of insulators and plates 218 are each positioned at opposing ends of the frame assembly 202. For example, insulators 220 can be made from at least one of foam or plastic and plates 222 can be made from metal comprising at least one of aluminum, galvanized metal, or stainless steel. In at least some embodiments, the insulators 220 can be made from a relatively rigid foam and the plates 222 can be made from aluminum. Additionally, the insulators 220 and the plates 222 can have substantially the same shape as the plurality of battery cells, plurality of stackable frames 204, and the plurality of compression pads 210, e.g., a generally rectangular shape.

One or more bolts 224 can extend through apertures 226 defined through each frame of the plurality of stackable frames 204 and each plate of the first pair of insulators and plates 216 and the second pair of insulators and plates 218. In the illustrated embodiment, four bolts and four apertures are shown. The one or more bolts 224 are configured to compress the plurality of stackable frames 204 together when the one or more bolts 224 are tightened such that an electrical connection between plurality of battery cells 206 and the printed circuit board assembly 208 is achieved (see FIGS. 2E and 3).

For example, the printed circuit board assembly 208 comprises right angle or L-shaped strips 228 (FIGS. 2A and 2E) that are configured to connect to the frame assembly 202 and the plurality of battery cells 206. For example, when the frame assembly 202 is in a partially compressed configuration, the I-shaped strips 228 are configured to be positioned in spaces between adjacent frames of the plurality of stackable frames 204. Thereafter, as described above, the bolts 224 can be tightened to compress the plurality of stackable frames 204 together to secure the printed circuit board assembly 208 to the frame assembly 202 and provide electrical communication between the plurality of battery cells 206 and the printed circuit board assembly 208. The I-shaped strips can be made from at least one of nickel, copper, or aluminum. In at least some embodiments, the I-shaped strips are made of nickel.

Once the pouch battery cell electrical configuration 200 is assembled, the pouch battery cell electrical configuration 200 can be connected to the energy storage system 114. For example, one or more mounting brackets 302 are configured to connect to the frame assembly 202 so that the frame assembly 202 can be connected to a chassis 300 of the energy storage system 114. In at least some embodiments, four mounting brackets are connected to the chassis 300 (e.g., screws, bolts, nuts, adhesives, etc.) and comprise opposing c-shaped fingers 304 that are configured to connect to (e.g., wrap around) the plates 222 of the first pair of insulators and plates 216 and the second pair of insulators and plates 218. The chassis 300 can be made of any material suitable for housing the pouch battery cell electrical configuration 200. In at least some embodiments, the chassis 300 can be made of plastic.

While the foregoing is directed to embodiments of the present disclosure, other and further embodiments of the disclosure may be devised without departing from the basic scope thereof, and the scope thereof is determined by the claims that follow.

What is claimed is:

1. An energy storage system, comprising:
a printed circuit board assembly configured to connect to a chassis of the energy storage system; and
a frame assembly comprising a plurality of stackable frames configured to connect to a plurality of battery cells and the printed circuit board assembly such that a series connection between the plurality of battery cells is created when the plurality of battery cells are connected to the plurality of stackable frames.

2. The energy storage system of claim 1, further comprising a plurality of compression pads, wherein each compression pad of the plurality of compression pads is configured to be positioned between two adjacent battery cells of the plurality of battery cells.

3. The energy storage system of claim 1, wherein each battery cell of the plurality of battery cells comprises a pair of tabs that are configured to provide the series connection between each battery cell of the plurality of battery cells.

4. The energy storage system of claim 1, further comprising a first pair of insulators and plates and a second pair of insulators and plates that are each positioned at opposing ends of the frame assembly.

5. The energy storage system of claim 4, wherein the first pair of insulators and the second pair of insulators are made from at least one of foam or plastic and the plates are made from metal comprising is at least one of aluminum, galvanized metal, or stainless steel.

6. The energy storage system of claim 4, further comprising four bolts that extend through four apertures defined through each frame of the plurality of stackable frames and each plate of the first pair of insulators and plates and the second pair of insulators and plates, wherein, when tightened, the four bolts are configured to compress the plurality of stackable frames such that an electrical connection between plurality of battery cells and PCBA is achieved.

7. The energy storage system of claim 1, wherein the printed circuit board assembly comprises L-shaped strips that are configured to connect to the frame assembly and the plurality of battery cells.

8. The energy storage system of claim 7, wherein the L-shaped strips are made from at least one of nickel, copper, or aluminum.

9. The energy storage system of claim 1, wherein the plurality of battery cells are a pouch battery cell electrical configuration.

10. The energy storage system of claim 1, further comprising mounting brackets that are configured to connect the frame assembly to the chassis.

11. An energy management system, comprising:
a distributed energy resource comprising a renewable energy source;
a load center connected to the renewable energy source; and
an energy storage system, comprising:
a printed circuit board assembly configured to connect to a chassis of the energy storage system; and
a frame assembly comprising a plurality of stackable frames configured to connect to a plurality of battery cells and the printed circuit board assembly such that a series connection between the plurality of battery cells is created when the plurality of battery cells are connected to the plurality of stackable frames.

12. The energy management system of claim 11, further comprising a plurality of compression pads, wherein each compression pad of the plurality of compression pads is configured to be positioned between two adjacent battery cells of the plurality of battery cells.

13. The energy management system of claim 11, wherein each battery cell of the plurality of battery cells comprises a pair of tabs that are configured to provide the series connection between each battery cell of the plurality of battery cells.

14. The energy management system of claim 11, further comprising a first pair of insulators and plates and a second pair of insulators and plates that are each positioned at opposing ends of the frame assembly.

15. The energy management system of claim 14, wherein the first pair of insulators and the second pair of insulators are made from at least one of foam or plastic and the plates are made from metal comprising is at least one of aluminum, galvanized metal, or stainless steel.

16. The energy management system of claim 14, further comprising four bolts that extend through four apertures defined through each frame of the plurality of stackable frames and each plate of the first pair of insulators and plates and the second pair of insulators and plates, wherein, when tightened, the four bolts are configured to compress the plurality of stackable frames such that an electrical connection between plurality of battery cells and PCBA is achieved.

17. The energy management system of claim 11, wherein the printed circuit board assembly comprises L-shaped strips that are configured to connect to the frame assembly and the plurality of battery cells.

18. The energy management system of claim 17, wherein the L-shaped strips are made from at least one of nickel, copper, or aluminum.

19. The energy management system of claim 11, wherein the plurality of battery cells are a pouch battery cell electrical configuration.

20. The energy management system of claim 11, further comprising mounting brackets that are configured to connect the frame assembly to the chassis.
